(19) United States
(12) Patent Application Publication
(10) Pub. No.: US 2018/0101918 A1
(43) Pub. Date: Apr. 12, 2018

(54) SYSTEM TO VERIFY MARKETABLE TITLE OF REAL ESTATE AND RELATED METHODS

(71) Applicant: Robert PALMER, Lake Mary, FL (US)

(72) Inventor: Robert PALMER, Lake Mary, FL (US)

(21) Appl. No.: 15/729,997

(22) Filed: Oct. 11, 2017

Related U.S. Application Data
(60) Provisional application No. 62/407,155, filed on Oct. 12, 2016.

(51) Int. Cl. G06Q 50/16; G06Q 30/00; G06F 17/30; H04L 29/08

(52) U.S. Cl. CPC G06Q 50/16; H04L 67/02; G06F 17/30861; G06Q 30/018

(57) ABSTRACT

A system to verify marketable title of real estate includes a graphical user interface (“GUI”) installed on a remote computer and configured for a user to transmit a request for a title defect indicator search for a selected piece of real estate. The system also includes a transmission server in electronic communication with a data source and the remote computer, and configured to receive the request for the title defect indicator search. The transmission server includes a microprocessor that is configured generate and transmit a title defect alert for a selected piece of real estate that includes a title defect indicator rating to the remote computer. In addition, the microprocessor is further configured to retrieve owner information of the piece of real estate from the data source, and transmit the owner information to a broker computer not associated with the user.

### RELATED APPLICATION

The present invention is related to U.S. Provisional Patent Application Ser. No. 62/407,155 filed Oct. 12, 2016, the entire contents of which are incorporated herein by reference.

### FIELD

The present invention relates to the field of real estate, and, more particularly, to a system to verify marketable title of real estate and related methods.

### BACKGROUND

A search of public land records for matters affecting the title to the real estate is performed as part of the process of purchasing real estate. The search is intended to report relevant issues related to the title of the particular piece of real estate. Instruments that can affect the title are found in the chain, or history, of ownership assembled from the records in a search. Examples of instruments that can create encumbrances on the title include open permits, deeds, wills, trusts, mortgage liens, judgment liens, tax liens, and easements.

The encumbrances may be cured in some cases. However, this takes additional time and money to resolve, which could lead to impacting the sale of the real estate. Also, additional problems can arise even after completion of a real estate transaction. For example, these hidden problems may include a forged deed that transfers no title to real estate, previously undisclosed heirs with claims against the property, instruments executed under expired or fabricated power of attorney, and mistakes in the public records.

Accordingly, verification of marketable title has traditionally been a labor intensive process. For example, title insurance companies may use title examiners, abstractors and searchers to verify marketable title. These individuals research title histories and laws to determine the possibility of a defect in title to the real estate. The research frequently requires searching databases for evidence of title.

Title insurance protects the purchasers and banks from defects in title. A home purchaser may be required to obtain title insurance prior to obtaining a mortgage on a home. Mortgagees and note purchasers may purchase title insurance to protect their collateral interest in a mortgage. Lien holders may also purchase title insurance to protect their collateral interest in the purchaser's debt.

The databases searched for evidence of title may be fairly extensive. For example, county databases may be searched for the chain of title for the real estate. Public record databases may be searched for evidence of mortgages or liens on the real estate. Court databases may be searched for evidence of judgment liens. Proprietary databases may also be searched for histories of title insurance. Any database containing information for evaluating the risk associated with underwriting title insurance for the real estate may be searched.

The large amount of effort required to verify marketable title often results in significant delays or errors in the underwriting process. The title underwriter may have to search multiple databases for title evidence, compare the evidence with voluminous business rules, create a title report and generate a title insurance product. This may result in significant delays or errors in the acquisition of secured financing or in closing a real estate transaction. The lengthy process also affects the sale of mortgages in secondary markets, decreases market liquidity and increases transaction time and cost.

As explained above, the verification of marketable title for real estate can be time consuming and costly. Accordingly, a system is needed where the complexity and cost of a real estate transaction can be significantly reduced by anticipating a potential title defect quickly and efficiently without performing a full title search and report.

### SUMMARY

In view of the foregoing background, it is therefore an object of the present invention to provide a system to verify marketable title of real estate and related methods. This and other objects, features, and advantages in accordance with the present invention are provided by a system that includes a graphical user interface (“GUI”) installed on a remote computer and configured for a user to transmit a request for a title defect indicator search for a selected piece of real estate.

The system also includes a transmission server in electronic communication with a data source and the remote computer, and configured to receive the request for the title defect indicator search, where the transmission server comprises a microprocessor and a memory that stores the user's destination address and preferred information format, and an identity of the selected piece of real estate. The microprocessor is configured to filter the received data for the selected piece of real estate from the data source by comparing the received data with a plurality of title defect indicator factors, generate a title defect alert from the filtered data that contains the identity of the selected piece of real estate and a title defect indicator rating, format the title defect alert into data blocks according to the information format, and transmit the formatted title defect alert to the remote computer based upon the destination address.

The formatted title defect alert activates the GUI to display the title defect indicator rating based upon the plurality of title defect indicator factors on the remote computer. The title defect indicator factors may include, for example, open permits, deeds, wills, trusts, mortgage liens, judgment liens, tax liens, and easements. In addition, the microprocessor is further configured to retrieve owner information of the piece of real estate from the data source, and transmit the owner information to a broker computer not associated with the user.

In another embodiment, a method to verify marketable title of real estate includes transmitting a request for a title defect indicator search for a selected piece of real estate using a GUI installed on a remote computer, and receiving the request for the title defect indicator search at a transmission server in communication with a data source. The transmission server includes a microprocessor and a memory that stores the user's destination address and preferred information format, and an identity of the selected piece of real estate.

The microprocessor filters received data for the selected piece of real estate from the data source by comparing the received data with a plurality of title defect indicator factors, generates a title defect alert from the filtered data that contains the identity of the selected piece of real estate and a title defect indicator rating, formats the title defect alert into data blocks according to the information format, and transmits the formatted title defect alert to the remote computer based upon the destination address.

The formatted title defect alert activates the GUI to display the title defect indicator rating based upon the plurality of title defect indicator factors on the remote computer. In addition, the microprocessor also retrieves owner information of the piece of real estate from the data source, and transmits the owner information to a broker computer not associated with the user.

One advantage of a particular illustrative embodiment of the invention, is that the prospective seller has an indication before placing the real estate on the market that there may be an issue that should be resolved now instead of later, which may delay the closing.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a flow diagram of a particular illustrative embodiment of a method to verify marketable title of real estate;

FIG. 2 is a diagram of a particular illustrative embodiment of a system to verify marketable title of real estate where an interface application (e.g., “GUI”) resides on a user's remote computer;

FIG. 3 is a general diagram of a system incorporating a microprocessor and a memory in which the system and method of FIGS. 1 and 2 to verify marketable title of real estate may be used; and

FIG. 4 is a particular illustrative embodiment of a graphical user interface (“GUI”) that may used with the system and method to verify marketable title of real estate.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

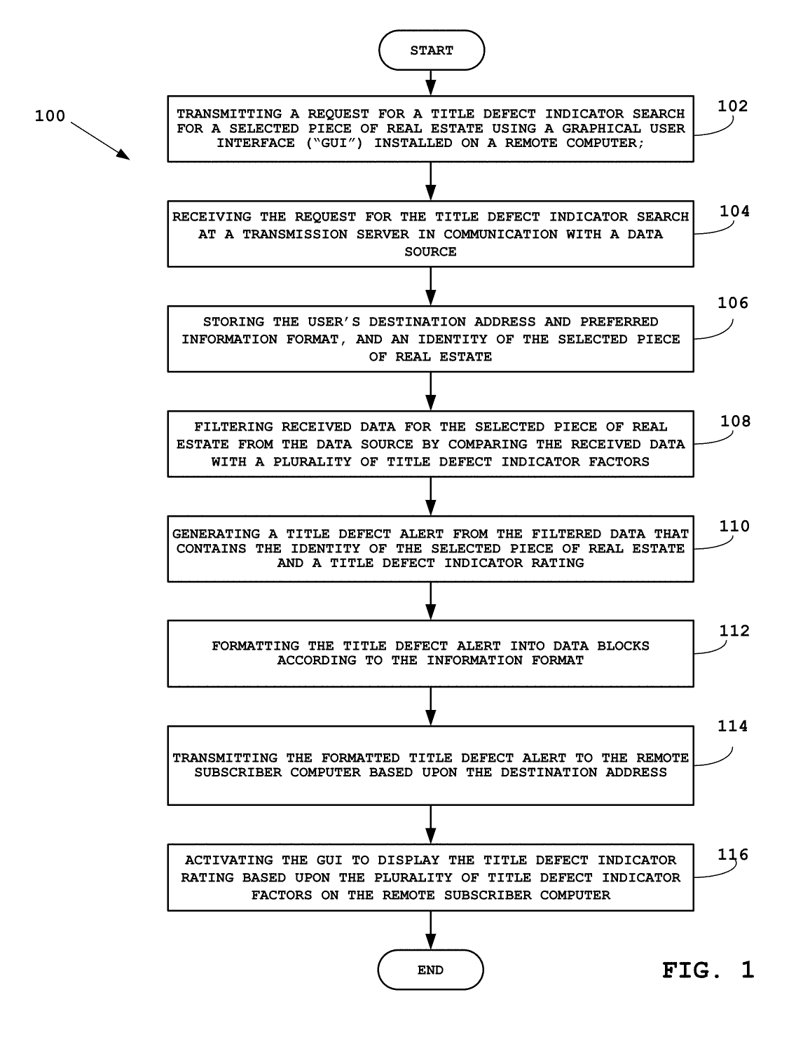

Referring initially to FIG. 1, a method to verify marketable title of real estate is generally designated 100. The method begins with transmitting a request for a title defect indicator search for a selected piece of real estate using a GUI installed on a remote computer, at 102. Moving to 104, the method includes receiving the request for the title defect indicator search at a transmission server in communication with a data source.

In addition, the method includes, at 106, storing the user's destination address and preferred information format, and an identity of the selected piece of real estate. The method also includes filtering received data for the selected piece of real estate from the data source by comparing the received data with a plurality of title defect indicator factors, at 108.

A title defect alert is generated, at 110, from the filtered data that contains the identity of the selected piece of real estate and a title defect indicator rating. At 112, the method includes formatting the title defect alert into data blocks according to the information format, and transmitting the formatted title defect alert to the remote computer based upon the destination address, at 114. In addition, the method includes activating the GUI to display the title defect indicator rating based upon the plurality of title defect indicator factors on the remote computer.

The microprocessor may also retrieve owner information for the piece of real estate from the data source, and transmit the owner information to a broker computer not associated with the user. The owner information received at the broker computer may be controlled by a real estate broker. Accordingly, the owner information can be used by the real estate broker to develop contacts in order to solicit representation for the potential real estate listing.

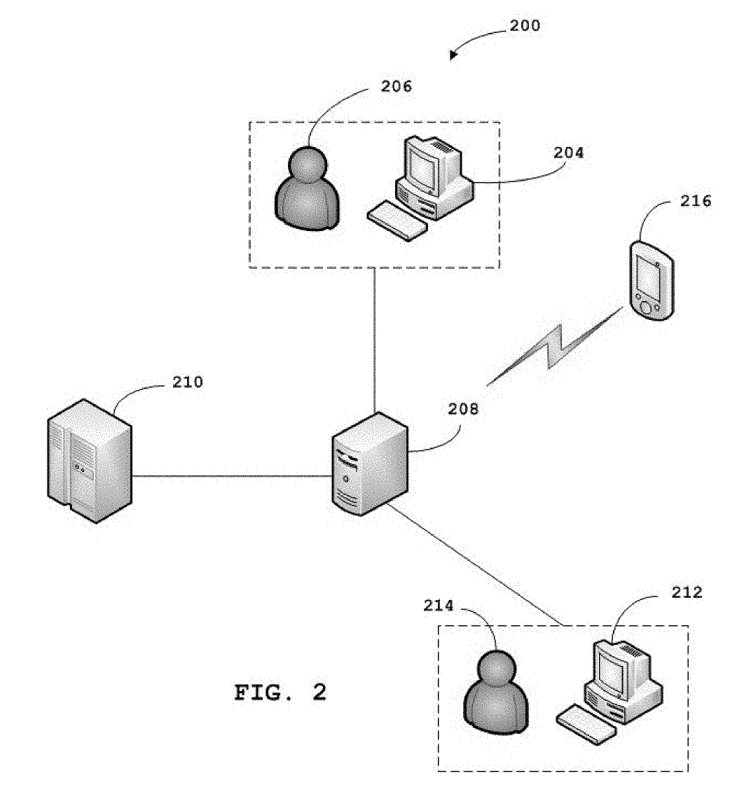

Referring to FIG. 2, a system to verify marketable title of real estate is shown and designated 200. The system 200 includes a remote computer 204 in communication with a transmission server 208. A wireless device 216 of the user may also be used instead of, or in addition to, the remote computer 204 in the system. A user 206 uses a GUI installed on the remote computer 204 (or the wireless device 216) in order to initiate the title defect indicator search for a selected piece of real estate. Typically, the selected piece of real estate would be owned by the user 206 who is considering listing the real estate for sale.

The transmission server 208 is in communication with a data source 210 using the Internet or a wireless communication network, for example. The data source 210 includes information related to real estate that could indicate a possible defect in the title. The data source is serviced by a third-party, in a particular embodiment, who compiles the data and makes it available on a subscription basis. However, the data could also be stored on the transmission server 208 in another particular embodiment.

For example, the data source 210 may include a plurality of databases. This could include one more of a title insurance claims database, credit repositories, flood database, tax liens database, and court judgments.

The title insurance claims database may list claims made against title insurance policies by the real estate owner. Prior claims made by a real estate owner may suggest future problems with the title insurance on a different piece of real estate. The claims database may′ include claims made against a bank's title insurance company or against the purchaser's title insurance company or both.

Credit repositories may include separate databases including credit information obtained from different credit reporting services. The credit information may be obtained from two different credit reporting services and cross-referenced to identify potential problems. For example, a lack of delinquencies can lead to the conclusion that the real estate owner is unlikely to have adverse judgments resulting in liens on the real estate.

The flood database may indicate whether the real estate is in a flood zone or has been the subject of a flood. If so, further investigation may be required.

The tax liens database may contain tax information relating to various borrowers and real estate properties. If the purchaser has had a tax lien filed against property that it owns, that could affect the likelihood that the subject real estate may also be the subject of a tax lien, and a full title search would discover the lien.

The court judgments database may contain information obtained from various court jurisdictions indicating adverse judgments against the purchaser. For example, this could include foreclosures, credit card or loan defaults, breaches of contract, bankruptcies, and child support orders. Open judgments may indicate a higher likelihood that a lien or attachment on the subject real estate exists, which would likely be discovered in a full title search.

Other databases may be used as part of the data source 210 to identify trade delinquencies, other mortgages, state statutes and regulations, for example. The information obtained from the various databases that serve as the data source 210 may be used to initiate the title defect indicator.

In addition, a broker computer 214 may be in communication with the transmission server 208. As explained above, the broker computer 212 may be controlled by a real estate broker 214 in order to develop contacts in order to solicit representation for potential real estate listings.

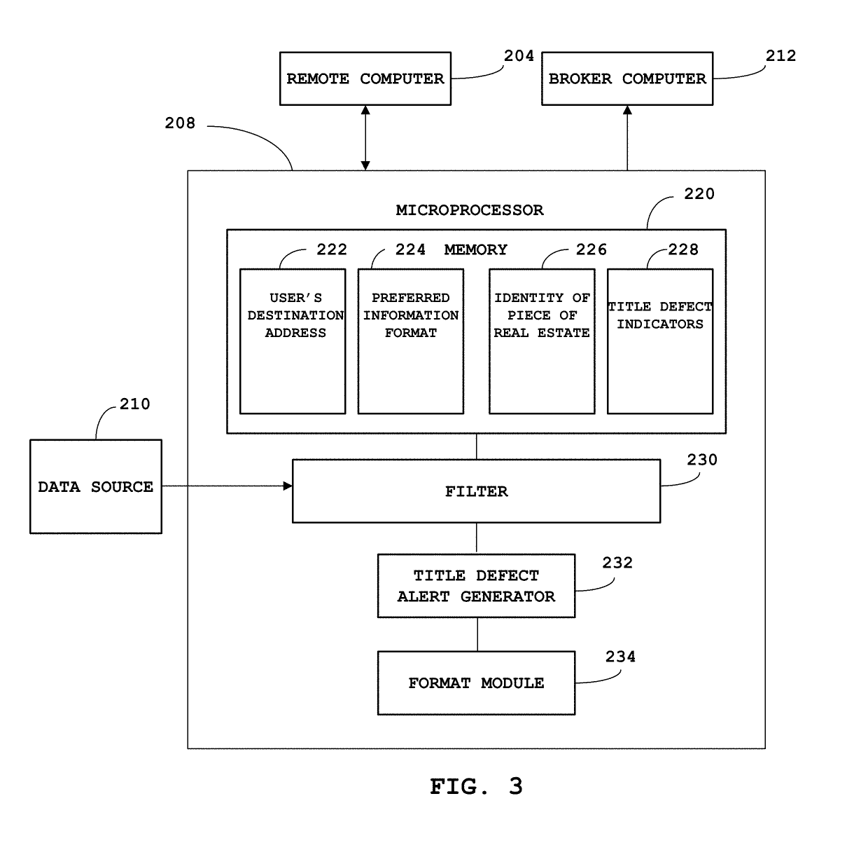

FIG. 3 is a general diagram of the transmission server 208, which includes a microprocessor and a memory 220. The memory 220 is used to store a user's destination address (e.g., IP address) 222, preferred information format 224, identity of the selected piece of real estate 226, and title defect indicators 228. A filter algorithm 230 is executed by the microprocessor in order to filter the received data for the selected piece of real estate from the data source 210 by comparing the received data with a plurality of title defect indicator factors 228 stored in the memory 220. Once the received data is filtered, a title defect alert algorithm 232 is executed in order to generate the alert. A format module 234 is used to format the title defect alert and to initiate the transmission to the remote computer 204. The title defect alert can also be transmitted to the broker computer 214, and contains owner contact information for the selected piece of real estate.

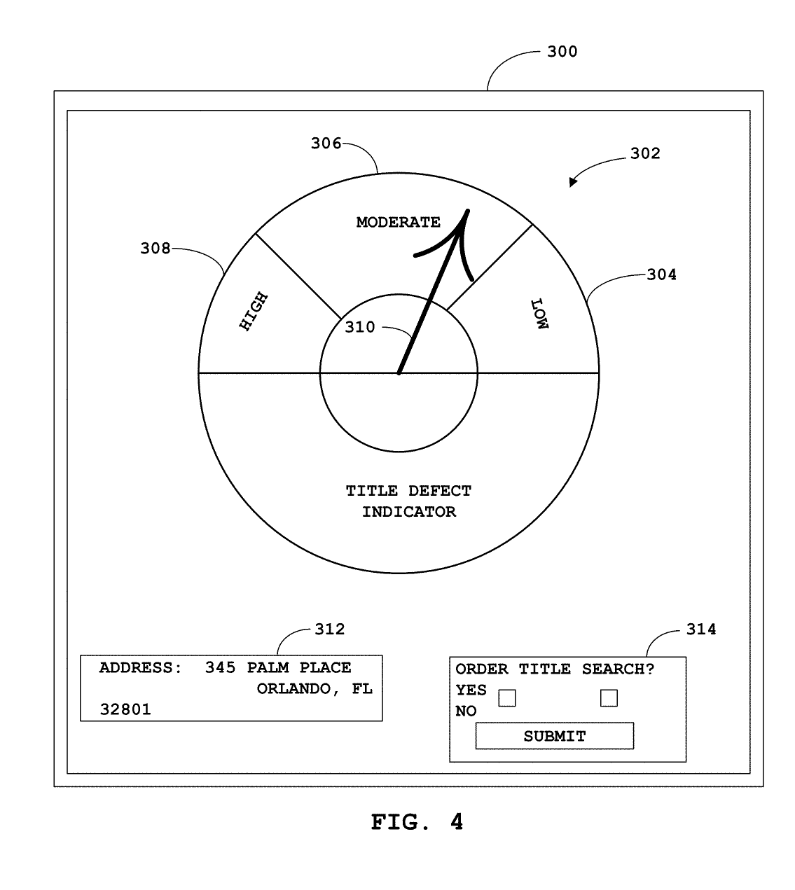

A title defect indicator rating is shown in FIG. 4, and designated 302, on a display 300 of the remote computer 204. The title defect indicator rating 302 is a graphical representation that conveys the likelihood of a title defect associated with the selected piece of property. In this particular example, a circular chart 304 includes three ranges, “Low” 304, “Moderate” 306, and “High” 308. A needle 310 is used to point to the area of the circular chart 304 to indicate the results of the filtering of the received data from the data source 210.

The address for the selected piece of real estate may be shown in a box 312 on the display 300, along with any other information pertaining to the real estate. In addition, a selection menu 314 may be provided that allows the user to select whether to order a full title search and report.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

That which is claimed is:

1. A system to verify marketable title of real estate comprising:
a graphical user interface (“GUI”) installed on a remote computer and configured for a user to transmit a request for a title defect indicator search for a selected piece of real estate;
a transmission server in electronic communication with a data source and the remote computer, and configured to receive the request for the title defect indicator search, wherein the transmission server comprises a microprocessor and a memory that stores the user's destination address and preferred information format, and an identity of the selected piece of real estate, wherein the microprocessor is configured to
filter the received data for the selected piece of real estate from the data source by comparing the received data with a plurality of title defect indicator factors,
generate a title defect alert from the filtered data that contains the identity of the selected piece of real estate and a title defect indicator rating,
format the title defect alert into data blocks according to the information format, and
transmit the formatted title defect alert to the remote computer based upon the destination address,
wherein the formatted title defect alert activates the GUI to display the title defect indicator rating based upon the plurality of title defect indicator factors on the remote computer.

2. The system to verify marketable title of real estate of claim 1, wherein the microprocessor is further configured to
retrieve owner information of the piece of real estate from the data source; and
transmit the owner information to a broker computer not associated with the user.

3. The system to verify marketable title of real estate of claim 1, wherein the data source comprises at least one of a title insurance claims database, credit repositories database, flood database, tax liens database, and court judgments database.

4. The system to verify marketable title of real estate of claim 1, wherein the user's destination address is an Internet Protocol (IP) address.

5. The system to verify marketable title of real estate of claim 1, wherein the remote computer comprises a wireless device.

6. The system to verify marketable title of real estate of claim 1, wherein the transmission server is in communication with the data source using the Internet or a wireless communication network.

7. The system to verify marketable title of real estate of claim 1, wherein the microprocessor is configured to generate a report illustrating the title defect indicator rating.

8. The system to verify marketable title of real estate of claim 7, wherein the report depicts a circular chart having a needle pointing to an area indicating a likelihood of a title defect associated with the selected piece of real estate.

9. The system to verify marketable title of real estate of claim 8, wherein the microprocessor is configured to generate a selection menu in order to initiate a full title search using the data source when selected.

10. A method to verify marketable title of real estate comprising:
transmitting a request for a title defect indicator search for a selected piece of real estate using a graphical user interface (“GUI”) installed on a remote computer;
receiving the request for the title defect indicator search at a transmission server in communication with a data source, wherein the transmission server comprises a microprocessor and a memory that stores the user's destination address and preferred information format, and an identity of the selected piece of real estate, wherein the microprocessor
filters received data for the selected piece of real estate from the data source by comparing the received data with a plurality of title defect indicator factors,
generates a title defect alert from the filtered data that contains the identity of the selected piece of real estate and a title defect indicator rating,
formats the title defect alert into data blocks according to the information format, and
transmits the formatted title defect alert to the remote computer based upon the destination address,
wherein the formatted title defect alert activates the GUI to display the title defect indicator rating based upon the plurality of title defect indicator factors on the remote computer.

11. The method to verify marketable title of real estate of claim 3, wherein the microprocessor is further
retrieves owner information of the piece of real estate from the data source; and
transmits the owner information to a broker computer not associated with the user.

12. The system to verify marketable title of real estate of claim 10, wherein the data source comprises at least one of a title insurance claims database, credit repositories database, flood database, tax liens database, and court judgments database.

13. The system to verify marketable title of real estate of claim 10, wherein the user's destination address is an Internet Protocol (IP) address.

14. The system to verify marketable title of real estate of claim 10, wherein the remote computer comprises a wireless device.

15. The system to verify marketable title of real estate of claim 10, wherein the transmission server is in communication with the data source using the Internet or a wireless communication network.

16. The system to verify marketable title of real estate of claim 10, wherein the microprocessor is configured to generate a report illustrating the title defect indicator rating.

17. The system to verify marketable title of real estate of claim 16, wherein the report depicts a circular chart having a needle pointing to an area indicating a likelihood of a title defect associated with the selected piece of real estate.

18. The system to verify marketable title of real estate of claim 18, wherein the microprocessor is configured to generate a selection menu in order to initiate a full title search using the data source when selected.

19. A system to verify marketable title of real estate comprising:
a graphical user interface (“GUI”) configured for a user to transmit a request for a title defect indicator search for a selected piece of real estate; and
a transmission server in electronic communication with a data source and the GUI, and configured to receive the request for the title defect indicator search, wherein the transmission server comprises a microprocessor and a memory.

20. The system to verify marketable title of real estate of claim 19, wherein the microprocessor is configured to filter received data for the selected piece of real estate from the data source by comparing the received data with a plurality of title defect indicator factors, and generate a report illustrating the title defect indicator rating, wherein the report depicts a circular chart having a needle pointing to an area indicating a likelihood of a title defect associated with the selected piece of real estate.
